(19) United States
(12) Patent Application Publication
(10) Pub. No.: US 2007/0078832 A1
(43) Pub. Date: Apr. 5, 2007

(54) METHOD AND SYSTEM FOR USING SMART TAGS AND A RECOMMENDATION ENGINE USING SMART TAGS

(75) Inventors: Edward Stanley Ott IV, Palo Alto, CA (US); Nathanael Joe Hayashi, Piedmont, CA (US); Matt Fukuda, San Francisco, CA (US)

Correspondence Address: GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/424,966

(22) Filed: Jun. 19, 2006

Related U.S. Application Data
(60) Provisional application No. 60/722,600, filed on Sep. 30, 2005.

(51) Int. Cl. G06F 17/30; G06F 7/00

(52) U.S. Cl. 707/3; 707/100

(57) ABSTRACT

The present invention relates to a system and method for recommending tags and/or content items in response to requests received from remote computing devices. In one aspect, a content item recommendation system comprises a database configured to store an identifier of a first content item, a first tag and information from which a tag density associated with the first tag and with the first content item may be derived. The tag density may be a measure of times a tag has been associated with a content item by any user of a plurality of users who are members of a community. The system also comprises a recommendation engine configured to receive search results containing the first tag from a search engine and to correlate the first tag with information stored in the database. The recommendation engine may be further configured to determine a recommended tag, based on a recommendation threshold and a tag density, the tag density associated with both the recommended tag and the first content item.

### RELATED APPLICATIONS

This application claims the benefit of U.S. Provisional Application No. 60/722,600, filed Sep. 30, 2005 which application is hereby incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The expansion of the Internet and the World Wide Web (“web”) has given computer users the enhanced ability to listen to and to watch various different forms of media through their computers. This media can be in the form of audio music, music videos, television programs, sporting events or any other form of audio or video media that a user wishes to watch or listen to.

Podcasting is a method of publishing digital media, typically audio programs, via the Internet, allowing users to subscribe to a feed of new files (e.g., .MP3s audio files). The word “podcasting” became popular in late 2004, largely due to automatic downloading of audio onto portable players or personal computers. Podcasting is distinct from other types of online media delivery because of its subscription model, which uses a “feed,” which may also be referred to as a “podcast,” to describe, identify and deliver a media file. A feed, in this context, refers to a list of files that can be easily interpreted to identify new files in the list as the files are added over time. Thus, one is said to subscribe to a feed because as new files are added to the list, the subscriber is notified of the new file and, in some cases, the new file is automatically delivered. The feed may exist as a discrete file, such as an .RSS file discussed below, or it may exist as part of some other data format or element.

Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and downloads new content automatically. Most podcatching software enables the user to copy podcasts to portable music players. Most digital audio players and computers with audio-playing software can play podcasts. From the earliest RSS-enclosure tests, feeds have been used to deliver video files as well as audio. By 2005 some aggregators and mobile devices could receive and play video, but the “podcast” name remains most associated with audio. Other names are sometimes used for casting other forms of media, such as blogcasting for text and vcasting or vodcasting for video. For the purposes of this application, podcast is used in its most general sense to refer to a feed of new files in any format (e.g., .MP3, .MPEG, .WAV, .JPG) and containing any content (e.g., text-based, audible, visual or some combination) that can be subscribed to by a client. Also, for the purposes of this discussion an individual podcast may be referred to as a series, and each distinct new file in the series may be referred to as an individual episode of the series.

Podcasting is supported by underlying feed formats such as RSS. RSS is a family of XML file formats for web syndication used by (amongst other things) news websites and weblogs. The abbreviation is used to refer to the following standards: Rich Site Summary (RSS 0.91); RDF Site Summary (RSS 0.9 and 1.0); and Really Simple Syndication (RSS 2.0).

The technology behind RSS allows a client, in a client-server environment, to subscribe to RSS feeds on websites maintained by remote servers; these are typically sites that change or add content regularly. To use this technology the client needs some type of aggregation service or aggregator. The aggregator allows a client to subscribe to the podcasts through which the client may get updates (i.e. future media files in the feed). Unlike typical subscriptions to pulp-based newspapers and magazines, many RSS subscriptions are free, but they typically only provide a line or two of each article or post along with a link to the full article or post.

The RSS formats provide web content or summaries of web content together with links to the full versions of the content, and other meta-data. This information is delivered as an XML file called RSS feed, webfeed, RSS stream, or RSS channel. In addition to facilitating syndication, RSS allows a website's frequent readers to track updates on the site using an aggregator.

A program known as a feed reader or aggregator can check RSS-enabled webpages on behalf of a user and display any updated articles that it finds. It is now common to find RSS feeds on major web sites, as well as many smaller ones. Client-side readers and aggregators are typically constructed as standalone programs or extensions to existing programs like web browsers. Such programs are available for various operating systems.

Podcasting has become a very popular and accepted media delivery paradigm. This success has caused the number and variety of podcasts available to clients to grow exponentially. Potential podcast consumers are now confronted with the problems of how to find podcasts, how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

### SUMMARY OF THE INVENTION

The present invention relates to a system and method for recommending tags and/or content items in response to requests received from remote computing devices. In one aspect, a content item recommendation system comprises a database configured to store an identifier of a first content item, a first tag and information from which a tag density associated with the first tag and with the first content item may be derived. The tag density may be a measure of times a tag has been associated with a content item by any user of a plurality of users who are members of a community. The system also comprises a recommendation engine configured to receive search results containing the first tag from a search engine and to correlate the first tag with information stored in the database. The recommendation engine may be further configured to determine a recommended tag, based on a recommendation threshold and a tag density, the tag density associated with both the recommended tag and the first content item.

In another aspect, a method of providing recommendations with results of a first search comprises retrieving a first tag from a set of results of a first search for content items, performing a second search based on the first tag, includes identifying a first content item that has been associated with the first tag. Wherein identifying a first content item includes determining a first tag density (where the first tag density is a measure of the number of times the first tag has been associated with the first content item) and making a determination based on the first tag density and a first threshold. Wherein the performing the second search includes identifying a recommended tag associated with the first content item. Wherein the identifying a recommended tag includes, determining a recommended tag density (wherein the recommended tag density is a measure of the number of times the recommended tag has been associated with the first content item) and making a determination based on the recommended tag density and a recommendation threshold.

In another aspect, a method comprises receiving a search request for content items associated with a first tag, generating a set of related tags based on the first tag, correlating the first tag and a candidate tag contained in the set of related tags to determine a recommended tag, and returning the recommended tag.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is a schematic illustrating an exemplary network architecture according to one embodiment of the present invention;

FIG. 2 shows an embodiment of a recommendation engine 202 and surrounding environment,

FIG. 3 is a flow-chart of an embodiment of a method 300 of providing a recommended tag;

FIG. 4 is a flow-chart of an embodiment of a method of performing a second search based on a tag contained in the results of a first search;

FIG. 5 is a flow-chart of an embodiment of a method of recommending a content item;

FIG. 6 is an embodiment of a method of using tags for generating an adaptive search utility in accordance with an embodiment of the present invention;

FIG. 7 is an embodiment of a user interface showing the results of a podcast search limited to series according to one embodiment of the present invention;

FIG. 8 is a flowchart depicting an embodiment of a method for generating revenue from podcasting in accordance with the present invention;

FIG. 9 is another exemplary user interface for publisher submission of a media file to the search engine according to one embodiment of the present invention;

FIG. 10 is a flowchart depicting in greater detail an embodiment of a method for recommending a tag and providing it in response to a request for a content item in accordance with the present invention;

FIG. 11 is a flowchart depicting in greater detail yet another embodiment of a method for selecting a tag in accordance with the present invention; and

FIG. 12 is an exemplary embodiment of a cloud of tags presented to signify varying densities.

### DETAILED DESCRIPTION OF PREFERRED EMBODIMENTS

In general, the present invention relates to a system and method for delivering media files over a network using associated identifiers (e.g., tags). As used herein, the terms “content”, “media”, or “media files” are used broadly to encompass any type or category of renderable, experienceable, retrievable, computer-readable file and/or stored media, either singly or collectively. Individual items of media or content are generally referred to as entries, songs, tracks, pictures, images, items or files, however, the use of any one term is not to be considered limiting as the concepts features and functions described herein are generally intended to apply to any storable and/or retrievable item that may be experienced by a user, whether aurally, visually or otherwise, in any manner now known or to become known. Further, the term media includes all types of media such as audio and video.

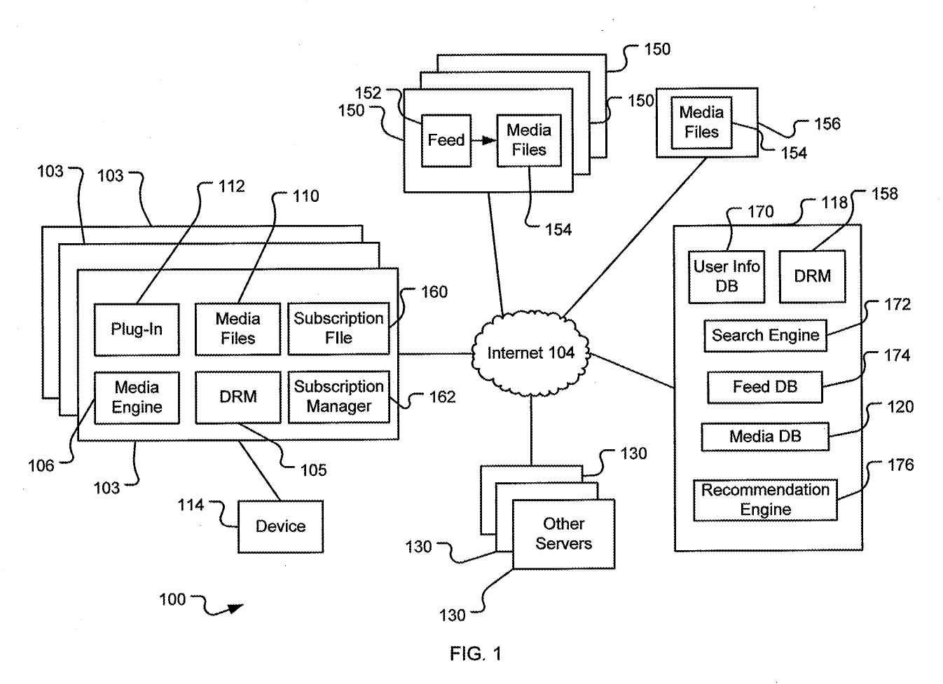

Embodiments of the present invention will now be discussed with reference to the aforementioned figures, wherein like reference numerals refer to like components. Referring now to FIG. 1, the architecture of one embodiment of the present invention is shown in schematic form. As can be seen in FIG. 1, a system 100 according to one embodiment of the present invention is shown. In general the system 100 allows users to experience, share and otherwise utilize different media. Although numerous exemplary embodiments will be discussed in terms of music and/or audio files, this invention can also be utilized with any form of audio, video, digital or analog media content, as well as any other media file type now known or to become known.

Each user may use a computing device 103, such as personal computer (PC), web enabled cellular telephone, personal digital assistant (PDA) or the like, coupled to the Internet 104 by any one of a number of known manners. Furthermore, each computing device 103 includes an Internet browser (not shown), such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. Each computing device also includes a media engine 106 that, among other functions to be further described, provides the ability to convert information or data into a perceptible form and manage media related information or data so that user may personalize their experience with various media.

A media engine 106 may be incorporated into computing device 103 by a vendor of computing device 103, or obtained as a separate component from a media engine provider or in some other art-recognized manner. As will be further described below, it is contemplated that the media engine 106 may be a software application, or a software/firmware combination, or a software/firmware/hardware combination, as a matter of design choice, that serves as a central media manager for a user and facilitates the management of all manner of media files and services that the user might wish to access either through a computer or a personal portable device or through network devices available at various locations via a network. As used herein, the term media file is used generically to refer to an item of media, as well as associated metadata and/or network location information for that item. A computing device 103 may also be referred to as a rendering device 103 to indicate that it is adapted to retrieve and render media files from the network.

Computing device 103 also may include storage of local media files 110 and/or other plug-in programs 112 that are run through or interact with the media engine 106. In one embodiment, media files 110 are audio files. In another embodiment, media files are video files. In yet another embodiment, media files can be a combination file compatible with a MPEG-21 standard or the like. Computing device 103 also may be connectable to one or more portable devices 114 such as a compact disc player and/or other external media file player, commonly referred to as an MP3 player, such as the type sold under the trade name iPod by Apple Computer, Inc., that is used to portably store and play media files.

Local files may be stored on a mass storage device (not shown) that is connected to the computing device 103 or alternatively may be considered part of the computing device 103. The mass storage device and its associated computer-readable media, provide non-volatile storage for the computing device 103. Although the description of computer-readable media contained herein refers to a mass storage device, such as a hard disk or CD-ROM drive, it should be appreciated by those skilled in the art that computer-readable media can be any available media that can be accessed by the computing device 103.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

Additionally, computing device 103 may contain Digital Rights Management software (DRM) 105 that protects the copyrights and other intellectual property rights of the user's media files by enabling secure distribution and/or preventing or hampering illegal distribution of the media files. In one embodiment, DRM 105 encrypts or decrypts the media files for controlled access by authorized users, or alternatively for marking the content with a digital watermark or similar method so that the content cannot be freely distributed. Media engine 106 preferably uses the DRM information to ensure that the media files being experienced through media engine 106 are not copied to or shared with users that are unauthorized to own, listen to or view the content.

The computing device 103 may include the software necessary to subscribe to podcasts. In the embodiment shown, the computing device 103 includes a subscription file 160, such as an OPML file. The subscription file 160 maintains information that identifies what podcasts the user has subscribed to. The subscription file 160 may include a list of feeds 152 and the locations of the feeds.

The computing device 103 also includes a subscription manager 162. The subscription manager 162 can perform the podcatching functions of an aggregator and can periodically poll the feeds identified in the subscription file 160 to determine if new episodes of the podcast are available. Upon determination that a new episode is available, the subscription manager 162 may notify the user or may automatically download the episode to the computing device, such as by retrieving it from a location, such as a media server 150, via the network 104. An example of a subscription manager is a module that performs a podcatching function, such as a software module.

The system 100 also includes subscription server 118. In addition to serving media over the Internet 104 to the user, subscription server 118 includes a media database 120, which, in addition to storing media files, also stores or communicates with storage devices storing various metadata attributes associated with particular pieces of media. Database 120 may be distributed over multiple servers provided with mass storage devices or other forms of computer-readable media or contained in a large mass storage device accessible the subscription server 118. Other servers 130 make other content and services available and may provide administrative services such as managing user logon, service access permission, digital rights management, and other services made available through a service provider. Although some of the embodiments of the invention are described in terms of music, embodiments can also encompass any form of streaming or non-streaming media including but not limited to news, entertainment, sports events, web page or perceptible audio, video or image content. It should be also be understood that although the present invention is described in terms of media content and specifically audio content, the scope of the present invention encompasses any content or media format heretofore or hereafter known.

The subscription server 118 also includes a database 170 of user information. The user information database 170 includes information about users that is collected from users or generated by the subscription server 118 as the user interacts with the subscription server 118. In one embodiment, the user information database 170 includes user information such as user name, gender, e-mail and other addresses, user preferences, etc. that the user may provide to the subscription server 118. In addition, the server 118 may collect information such as what podcasts the user has subscribed to, what searches the user has performed, how the user has rated various podcasts, etc. In effect, any information related to the user and the podcasts that user subscribes to that is available to the subscription server 118 may be stored in the user information database 170

The user information database 170 may also include information about a user's devices 114. The information allows the subscription server 118 to identify the device and differentiate it from the computing device 103. Furthermore, it is anticipated that a single user may have multiple different computing devices 103 and each computing device 103 may be associated with different information. For example, a user may subscribe to a news podcast on a mobile device such as a smart phone 103 or similar Internet connected mobile device 103 and may subscribe to a gaming podcast on a home computer 103. The user information database 170 contains all this information. In one embodiment, the user information database 170 may include the same information contained in the computing device's subscription file 160 for each computing device 103 associated with the user. The user information database 170 may even include one or more files in the OPML file format for each user.

In the embodiment shown, the subscription server 118 includes a feed database 174. The feed database 174 may include a list of podcasts known to the server 118. This list may be periodically refreshed as the server 118 searches for new feeds 152 and for feeds 152 that have been removed from access to the internet 104. Such a feed database 174 may not be necessary if the searching ability of the server 118 is sufficient to quickly provide user with updated and accurate feed information in response to a user search. The feed database 174 may include all of the information provided by the feed 152. In addition, the feed database 174 may include other information generated by the subscription server 118 or by users. Thus, the feed database 174 may contain information not known to or generated by the publisher of the feed 152.

In one embodiment, the databases 120, 174, 170 may be separate and distinct databases, while in an alternative embodiment some or all of the databases 120, 174, 170 may be combined into a single database. The databases 120, 174, 170 part of the server 118 or may be located on separate computing devices that are in communication with the server 118.

In an embodiment, the feed database 174 includes additional information regarding feeds 152 in the form of “tags.” A tag is a keyword chosen by a person accessing the subscription server 118 to describe a particular feed 152. The tag can be any word or combination of key strokes. Each tag submitted to the subscription server may be recorded in the feed database 172 and associated with the feed the tag describes. Tags may be associated with a particular feed 152 (e.g., a series tag) or associated with a specific media file 154 within the feed 152 (e.g., an episode tag). Tags will be discussed in greater detail below. In an alternative embodiment a tag may also be a media file such as an icon, an image or an audio file.

Since tags can be any keyword, a typical name for a category, such as “science” or “business,” may also be used as a tag and in an embodiment the initial tags for a feed are automatically generated by taking the category designations from a feed and using them as the initial tags for the feed.

However, note that tags need not be though of only as a hierarchical category system that one “drills down” through. Tags are not generally hierarchically related as is often required in the typical categorization scheme. A group of tags may be instead related by a web or network, with each connected to each other tag, with connections of varying strengths, natures and degrees. For example, a tag may be related to another tag through both tags being associated with the same content item. The strength of the relationship, may depend on a number of times each tag has been associated with that content item by a user. The number of times may be used to determine a metric referred to as a “tag density” of the tag in relation to the content item. Tag densities and how they are created will be discussed further below.

The types of relationships between tags may vary as well. For example, two tags may be related because they are associated with the same content item. In another example, two tags may be related because a single user used both to describe a single content item. In yet another example, two tags may be related because users often use either one or the other tag to describe a content item, but less often use both to describe a content item (e.g., the two tags may be satire and humor). In yet another example, users may often select one tag after selecting another (e.g., “humor” followed by “Dave Chappelle”).

A tag may have any number of relationships with another tag. For example, a tag may be related to another tag in one manner based on being associated with the same content item. In yet another example, two tags may be associated by users of one demographic but not associated by users of another demographic. In another example, two tags may be related more for one type of content item (e.g., feeds, audio files, movie trailers) than for another type of content item.

Tags may also be used in a cumulative manner in that the number of users that identify a series or an episode with a specific tag may be counted or tracked. In one embodiment, each instance where a user associates a tag with a content item (e.g., a series, an episode, a file, a part of a file, a feed) is tracked and may be used to analyze and create metrics about any relationships between tags (e.g., relating to a certain content item, relating to a particular user subgroup).

In another embodiment, analyses of information (or otherwise aggregated information) about associations between tags and content items may be stored. For example, tag densities may be stored based on the number of users that have associated that tag with the content item. Tag densities may be used to indicate the relative accuracy of the specific tag description of the associated content (i.e., series or episode). Tag densities, like any other aggregated or analyzed data may be calculated from raw data when requested or on a “real time” basis.

In an embodiment, consumers of feeds 152 are allowed to provide information to be associated with feeds or with particular episodes of feeds. Thus, the user after consuming data may rate an episode, say on a scale of 1-5 stars, write a review of the episode, and enter tags to be associated with the episode. Consumer-generated data may be stored in the feed database 174 and associated with the appropriate episode for use in future searches.

The subscription server 118 includes a search engine 172. In an embodiment, the search engine 172 performs multiple functions including crawling the network 104 to identify feeds and episodes of feeds on the network 104, retrieving feed information and storing it in the feed database 174, and providing a means for computing devices 103 to easily search the feed database 174 for feeds and episodes.

Because of their very nature, feeds 152 are expected to change over time through the addition of new media files 154 as episodes of the feed 152. In an embodiment, the search engine 172 periodically and automatically crawls the network 104 to find new feeds 152 and to find previously identified feeds 152 that have changed since the last time the search engine 172 inspected the feed 152. When crawling the network 104, the search engine 172 can use any network searching or crawling methods, such as for example, the method for crawling information on a network described in commonly owned U.S. Pat. No. 6,021,409, titled “METHOD FOR PARSING, INDEXING AND SEARCHING WORLD-WIDE-WEB PAGES.” The search engine 172 may create one or more new entries in the feed database 174 for every new feed 152 it finds. Initially, the entry or entries may contain the location of the feed, an identifier of the feed (such as its name), and some or all of the information contained in or otherwise provided by or associated with the feed 152. For example, for an RSS feed this information may include some or all of the metadata within the RSS feed file. This feed information is retrieved by the search engine 172 from the feed 152 and stored in the feed database 174 so that the feed database contains some or all of the information provided in the feed 152. Such information may include the feed description, episode descriptions, episode locations, etc.

An automatic analysis may or may not be performed to match the feed 152 to known tags based on the information provided in the feed 152. For example, in an embodiment some RSS feeds include a category element and the categories listed in that element for the feed may be automatically used as the initial tags for the feed. While this is not the intended use of the category element, it may be used as an initial tag and as a starting point for the generation of more accurate tags for the feed. Note that client searches on terms that appear in the feed 152 will return that feed as a result, so it is not necessary to provide tags to a new entry for a client search to work properly. Initially no user-generated ratings information or user reviews are associated with the new entry. The manager of the subscription server may solicit additional information from the publisher such as the publisher's recommended tags and any additional descriptive information that the publisher wishes to provide but did not provide in the feed 152 itself.

The feed database 174 may also include such information as reviews of the quality of the feeds, including reviews of the series as a whole and reviews specific to each episode in a given feed 152. The review may be a rating such as a “star” rating and may include additional descriptions provided by users.

In addition to maintaining information specific to series and individual episodes within the series, the feed database 174 may also include information associated with publishers of the feeds, sponsors of the feeds and/or episodes, topics discussed in the feeds or episodes or people in the feeds or episodes.

The feed database 174 may also include information concerning advertisers and advertisements associated with feeds and episodes. For example, associated with each feed may be a set of one or more advertisers or advertisements. This information may then be used to select an advertisement to be transmitted or streamed to a consumer's computing device 103 as will be described in greater detail below.

In order to facilitate client searches for podcasts, the feed search engine 172 may provide a graphical user interface to user's computing devices 103 allowing the user to search for and subscribe to feeds 152 using the subscription server 118. In one embodiment, the graphical user interface may be an .HTML page served to a computing device 103 for display to the user via a browser. Alternatively the graphical user interface may be presented to the user through some other software on the computing device 103. An example of a graphical user interface presented to a user by a browser is discussed with reference further below.

Through the graphical user interface, the feed search engine 172 receives user search criteria. The search engine 172 then uses the search criteria as parameters to identify feeds 152 that meet the user's criteria. The search may include an active search of Internet 104, a search of the feed database 174, or some combination of both. The search may include a search of the descriptions provided in the feed 152 of the series and each particular episode in the series. The search may also include a search of the third party-provided tags, ratings, and reviews and other information associated with feeds 152 listed in the feed database 174 but not provided by the feeds 152 themselves. The results of the search are then displayed to the user.

In one embodiment of the present invention, similar to the DRM software 105 located on the user's computing device 103, the subscription server may maintain its own DRM software 158 which tracks the digital rights of media files located either in the media database 120 or stored on a user's computing device. Thus, for example, before the subscription server 118 streams, “serves up,” or transfers any content item to a user, it validates the rights designation of that particular content item and only serves streams or transfers the content item if the user has the appropriate rights. This may be determined by an inspection of information contained on the computing device 103, in the user information database 170, or both.

The system 100 also includes a number of media servers 150, which are remote from the computing devices 103 and from the subscription server 118, that publish podcasts. In one embodiment “remote” means remote in the logical, network sense in that each media server 150, each computing device 103 and the subscription server 118 may be accessed using different domain names as their network locator, such as a Uniform Resource Locator (URL) or Uniform Resource Identifier (URI). For example, the subscription server 118 may be accessed by a URL of “http://podcast.yahoo.com” while each media server 150 may have a different URL such as “www.abcnews.com” and “www.itunes.com”. The computing devices 103 may have dedicated URLs or may be devices that can intermittently connect to the Internet 104 and are given temporary URLs by the system through which they connect. In another embodiment, Internet Protocol (IP) addresses for each computing device 103, media server 150 and the subscription server 118 are different, indicating that the devices are remote from each other, at least in a logical sense.

The servers 150 include one or more feeds 152, such as RSS feeds, that are accessible through a network 104, such as the Internet as shown. The feeds 152, as will be described in greater detail below, include information about the feed (series information) as well as information about the various media files 154 (i.e., episodes) of the feed 152. The feed 152 also identifies the media files 154 so that they can be retrieved by a subscription manager on a computing device 103. The media file 154 may reside on the media server 150 with the feed 152, or may be located on yet another server 156 that is, in fact, remote from the podcast server 150 with the feed 152.

As illustrated in FIG. 1, each user's computing device 103, the subscription server 118 and media servers 150, as well as the other servers 130, 156 are communicatively connected via the Internet 104. In alternate embodiments, different components of the system may be communicatively coupled differently, for example each may be coupled directly to each other wirelessly or by a local or wide area network (WAN) or the like. Additionally, functional components can be distributed so that certain functions of the search engine 172 may be performed at the subscription server 118, or distributed in modular fashion for operation at various locations throughout the system 100. Thus, each description herein of a function or component being associated with a particular device or component or location is merely one possible embodiment.

The search engine 172 also provides users with additional functionality and convenience. A user interface provided by the search engine 172 to the user's computing device 103 may allow the user to subscribe to a displayed feed (via a subscribe button), listen to an episode of a displayed feed (via listen button), and obtain the complete information on the feed (via clicking on the hyperlinked title) from the same interface. A user need not know where the feed resides on the Internet and need only to interact with the search engine's user interface to perform these actions. Furthermore, the user does not need to explicitly direct his computer to access the publisher's site to subscribe, listen or obtain additional information on a feed.

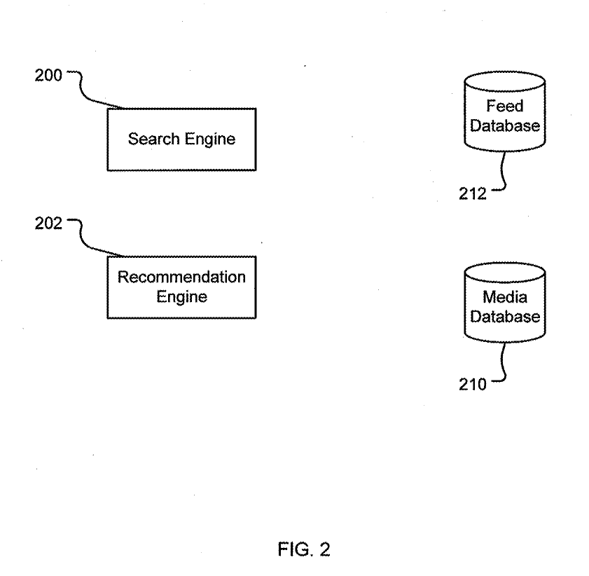

The system 100 also includes a recommendation engine 176. The recommendation engine 176 may be used by the subscription server 118 to analyze data relating to tags associated with content items and to recommend tags and/or content items to a user based on a number of factors. The recommendation engine 176 may access the feed database 174 and the media database 120 in response to a request from the search engine 172. In addition, the recommendation engine 176 may access the user information database 170, the DRM 158 or other parts of the subscription server 118 to analyze data and generate recommended tags. The functioning of the recommendation engine 176 will be described further with respect to FIG. 2.

FIG. 2 shows an embodiment of a recommendation engine 202 and surrounding environment. The recommendation engine 202 interacts with the search engine 200, the feed database 212 and the media database 210 to create recommendations for users. For example, the recommendation engine may provide recommended tags and/or content items based on a search performed by the search engine 200 at the request of a user. The search engine may present the recommended tags and/or content items along with the results of the search requested or separately.

The recommendation engine 202 and the search engine 200 may both use the feed database 212 and the media database 210 and both return tags and/or content items. However, the recommendation engine 202 may use the databases differently than the search engine 200. For example, the recommendation engine 202 may intentionally search for a recommendation in the form of a different tag or criterion than a search criterion received by the search engine 200. In order to search for a recommendation (a different tag or criterion), the recommendation engine may rely on information stored in the databases (and aggregations/analyses thereof). The recommendation engine 200 therefore may access the feed database 212 and the media database 210 in a different manner and for different purposes than the search engine 200.

Tags may be related in many manners as described further herein. Tags are largely related through content items, and in particular, through being associated with content items by users in the community.

In one embodiment, the recommendation engine 202 may use information in the feed database to determine relationships between tags. In another embodiment, the recommendation engine 202 may use information in the media database to determine relationships between tags.

In one embodiment, the recommendation engine 202 may create aggregated datasets or reports of information contained in the feed database 212, to be stored for later use. For example, these reports may be used by the recommendation engine 202 or another entity to expedite recommendations and/or searches, or may be used to provide census data to system administrators or publishers.

In one embodiment, the recommendation engine 202 creates customized specific recommendations based on a particular set of circumstances surrounding a search or other inquiry. For example, a time of day at which an association of a tag was made with a content item may affect the recommendations made, depending on the types of relationships between tags that are important in the recommendation. In such a case the recommendation engine 202 may need to create a recommendation on a “real time” basis. The recommendation engine 202 may use “raw data” in the feed database 212 and the media database 210 to create a recommendation based on the specific requirements of the situation. Raw data may include records of all the instances and circumstances when a user has associated a tag with a content item in the past.

In another embodiment, the recommendation engine 202 may use a combination of raw data and previously aggregated data. For example, aggregated data may indicate that two tags are used as synonyms generally, and raw data may be used to correlate two users' standard preferences after comparing the two users' recent search patterns.

In one embodiment, aggregated data is stored intermixed with raw data in either the media database 210 or the feed database 212. For example, a record of instances of tags being associated with a particular content item may be stored along with an updated/changing measure of each of the tag's density with respect to that content item.

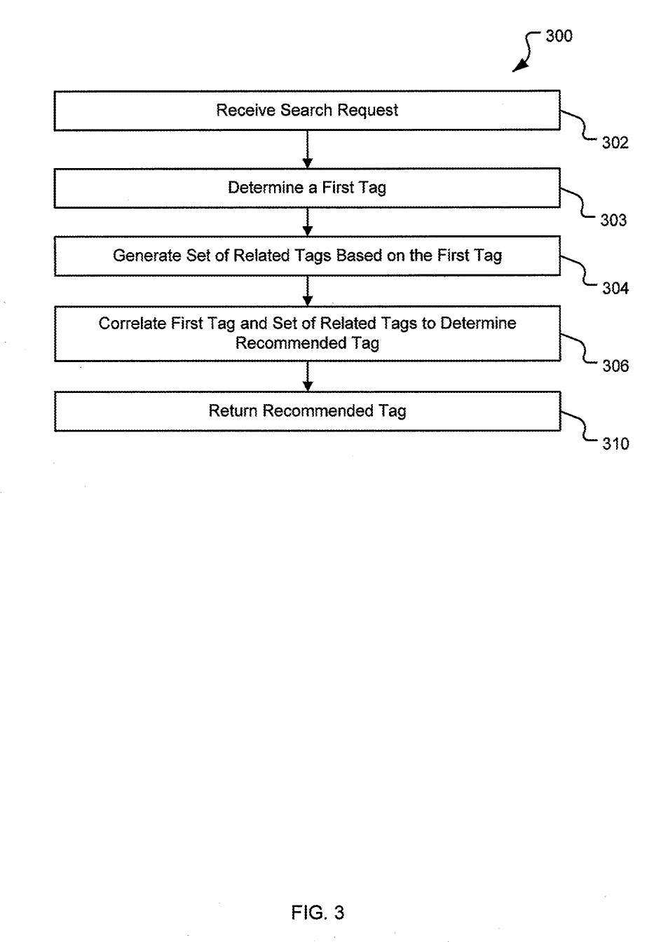

FIG. 3 is a flow-chart of an embodiment of a method 300 of providing a recommended tag. The method 300 receives a search request 302 for content items. A set of search results may be created by another entity, retrieved from a database, or may be otherwise created.

In the embodiment shown, a first tag is determined 303. In one embodiment, the first tag may be determined 303 by taking a tag from the search results. For example, the search results may be a group of content items and the first tag may be a tag that is associated with a number of the content items, or may be a tag is that is strongly associated with a number of the content items. In another embodiment, the first tag may be associated with a content item by users who rated the content item highly. In yet another embodiment, the search request may contain the first tag. For example, a user may enter the first tag as a search term.

In the embodiment shown, a set of related tags is generated 304 based on the first tag. The set of related tags may be generated 304 by collecting content items that are associated with the first tag, or content items that are returned by the search. The collected content items will often be associated with other tags which are different than the first tag, but are each related to the first tag through being associated with a content item. In one embodiment, the relationship between the first tag and each tag of the set of related tags is that each of the related tags is associated with a content item that is also associated with the first tag. In other words, one or more of the content items share the first tag and one of the related tags. The process of collecting content items to generate 304 a set of related tags is described in further detail herein.

In an embodiment, the first tag is correlated 306 with at least one of the set of related tags. The correlation may be performed in many manners. In one embodiment, the first tag may be correlated 306 only with related tags which are associated with highly-rated content. In another embodiment, the first tag may be correlated 306 with tags as they are added to the set of related tags (e.g., through the generation operation 304). In yet another embodiment, the first tag may also be correlated 306 with tags based on a history of other correlations that have been performed between tags. In one embodiment, a memory may be accessed to retrieve previous results of correlations performed between tags. Tag-to-tag correlation and tag-to-content item correlation is described in further detail herein.

When a sufficiently-correlated candidate tag is found, the candidate tag may be recommended based on the correlation. Thus, a candidate tag may be recommended based on a positive correlation between the candidate tag and the first tag.

When a recommended tag is determined, the recommended tag is returned 310. In one embodiment, the returning 310 may be in the form of a web-based user interface. In another embodiment, the returning 310 may be performed by transmitting the recommended tag to a software module. In yet another embodiment, the returning 310 may be performed by storing the recommended tag in a memory.

It should be noted that the processes described herein may be performed simultaneously, repeatedly, and recursively. For example, the generation 304 of a set of tags may occur at the same time as members of the set of tags are correlated 306 with the first tag. The processes herein may also be performed individually, with the end of one process triggering the beginning of the next process. The end of one process may also be followed by a period of time (e.g., a waiting period) before another process is begun.

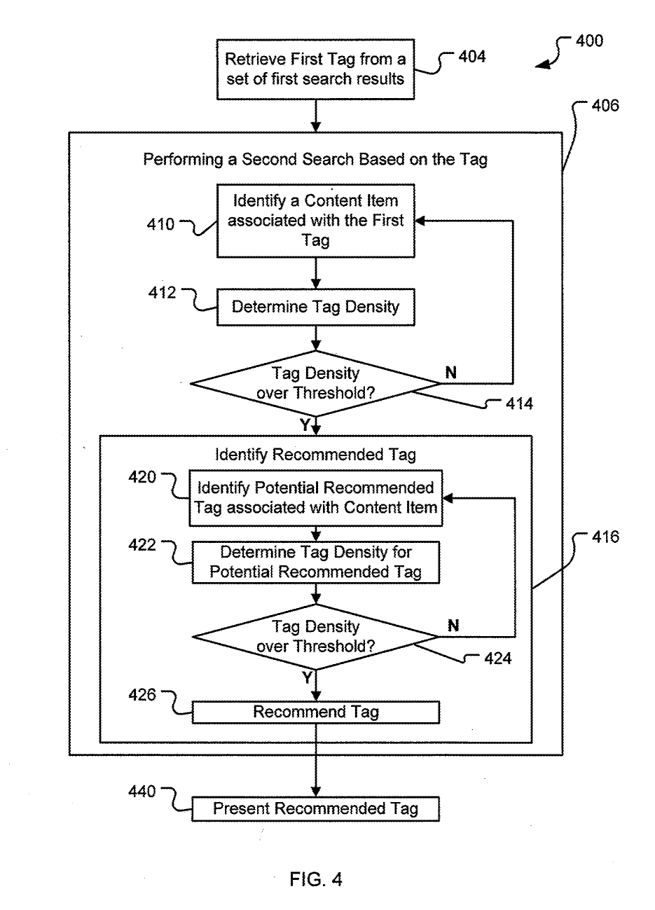

FIG. 4 is a flow-chart of an embodiment of a method 400 of performing a second search based on a tag contained in the results of a first search. In the embodiment shown, the method begins with retrieving a tag 404 from a set of first search results. The method 400 performs a second search 406 based on the tag retrieved from the set of first search results.

Performing a second search 406 may provide recommendations to a user or help a user narrow or redirect his search for content items. For example, a user may be looking for a content item, but not know how to describe it. In another example, a user may be looking for tags that will better describe what he is seeking. In yet another example, a user may be browsing. Performing a second search 406 serves to provide recommendations of tags or content items that are related to the search the user originally requested. The relationships between the content items, tags and the first search may vary depending on application, and the types of relationships are described in further detail herein.

Performing a second search 406 may be performed in a number of manners. Performing a second search 406 may be performed (as shown) based on a “second search tag” (e.g., a first tag as described with respect to FIG. 3, a sponsored tag, a tag from the user's search history), or, in another embodiment (not shown) based on a content item or part of a content item (e.g., information in a category field, names of performers, locations in a content item). Performing a second search 406 may be performed using aggregated data or raw data, as described further herein. For example, the second search may be performed 406 via comparing tag densities, creating tag densities based on different selection criteria, and using any information that may provide more accurate recommendations.

Performing a second search 406, in the embodiment shown, comprises identifying a content item associated with the first tag 410 to a sufficient extent, and identifying a tag associated with that content item 420 to a sufficient (and possibly, different) extent. The tag so identified 420 may be recommended 426 and presented 430 to a user.

Identifying a content item 410 associated with the second search tag may provide a group of tags each of which is at least somewhat related to the second search tag, because each tag is associated with that content item. The level of relation may be determined partially by determining a tag density 412 (e.g., for the second search tag) associated with content item. Determining a tag density 412 may include retrieving the tag density if the tag density is stored or generating the tag density (e.g., in real-time) from data stored relating to the tag and the content item (e.g., raw data, aggregated data).

In the embodiment shown, the tag density may be compared 414 with a threshold. In an embodiment, if the tag density is greater than the threshold, then the content item has a sufficient association with the second search tag. Those with skill in the art will recognize that meaningful comparisons or correlations may be made in other manners (e.g., performed by comparing a value to see if it is under a threshold). In one embodiment, if the tag density does not indicate a sufficient association between the content item and the second search tag, the method 400 may return to identify another content item 410 associated with the second search tag. In another embodiment, even if the content item is sufficiently associated with the second search tag, the method 400 may return to identify another content item 410 associated with the second search tag. For example, a list of related tags may be created from multiple content items (e.g., each of which having sufficient association with the second search tag) before identifying a recommended tag 416. Thus, the method 400 may recursively search for an appropriate content item 410 associated with the second search tag.

The tag density and the threshold used in the comparison may contain a broad range of information and may be created specifically for the search, the second search and/or the recommendation. For example, the density and threshold may take into account any aggregated or raw data (as described further herein).

In one embodiment, after at least one content item is identified, the method 400 identifies a recommended tag 416. In the embodiment shown, the recommended tag is picked from the set of related tags that is assembled from the content item(s) associated with the second search tag. In one embodiment, the recommended tag is picked in much the same manner as described above with respect to picking a content item that is sufficiently associated with the second search tag. For example, a potential recommended tag's tag density is determined 422 relating to a content item of the group of content items that has sufficient association with the second search tag. If the potential recommended tag's tag density is above a threshold 424, then the potential recommended tag may be recommended 426. If the tag density is not above the threshold 424, then the identifying a recommended tag operation 416 may return to identifying another potential recommended tag 420.

Those with skill in the art will recognize that the embodiment shown is only one of many ways in which similar processes may be performed. For example, there are many implementations known to those skilled in the art for searching a group of files (e.g., content items) or items in a database, and specifically, methods of choosing an order for inspecting items. In addition, there may be other processes affecting the identification of content items 410 or the determining of tag densities 412, 422, including sponsored or featured content items, advertisements, parental controls (e.g., content filters), and user history data.

In one embodiment, the method 400 may be performed a number of times, or performed repeatedly, perhaps in parts. For example, multiple content items may be collected in order to build a large set of related tags. Multiple content items may be collected by identifying another content item 410 after one content item is sufficiently associated with the second search tag. In addition, multiple operations may be performed simultaneously to produce more that one recommendation (e.g., recommended tag, recommended content item). It should be understood that the method 400 may be performed in several orders, as those with skill in the art will recognize, while still practicing the fundamental processes embodied in the method 400.

In the embodiment shown, once a potential recommended tag is recommended 426, the recommended tag may be presented 430 to a user. In one embodiment, the method 400 may present the recommended tag with the results of the first search, either near the results or in another area. In another embodiment, the method 400 may present the recommended tag only on request of a user. In one embodiment, the recommended tag may be presented 430 to a user via a graphical user interface (GUI) such as the GUIs described further herein.

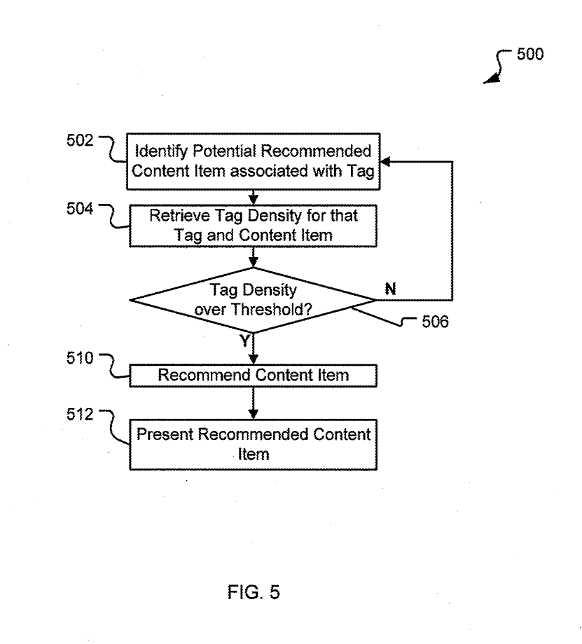

FIG. 5 is a flow-chart of an embodiment of a method 500 of recommending a content item. The method 500 may be used in place of, or in addition to the methods described above in relation to identifying a recommended tag 416. The method 500 may also be performed simultaneously, before or after the identifying a recommended tag operation 416. The method 500 may also be performed independently from other operations. For example, the method 500 may be performed in anticipation of a user performing a search or in order to create aggregate data (e.g. recommendations).

The method 500 may be performed in much the same manner as described in detail above with respect to identifying a recommended tag 416. Indeed, the method 500 may be performed in any of manners described above with respect to identifying a recommended tag 416.

A potential recommended content item that is associated with a tag is identified 502. The identifying a content item associated with a tag 502 may be performed in the same manner as the identifying a potential recommended tag associated with a content item (e.g., 420) as described further herein. The process may be similar, as well, to the other processes of identifying a content item associated with a tag (e.g., 410).

After the potential content item is identified 502, a tag density may be retrieved 504. For example, the tag density associated with a recommended tag may be retrieved 504 (e.g., generated, requested from a memory) for the potential recommended content item. The tag density may then be compared 506 with a threshold in order to determine if the content item should be recommended 510. Once a content item is recommended 510, the recommended content item may be presented 512 in any of the manners described herein or known in the art (e.g., through a hyperlink, streaming, downloaded).

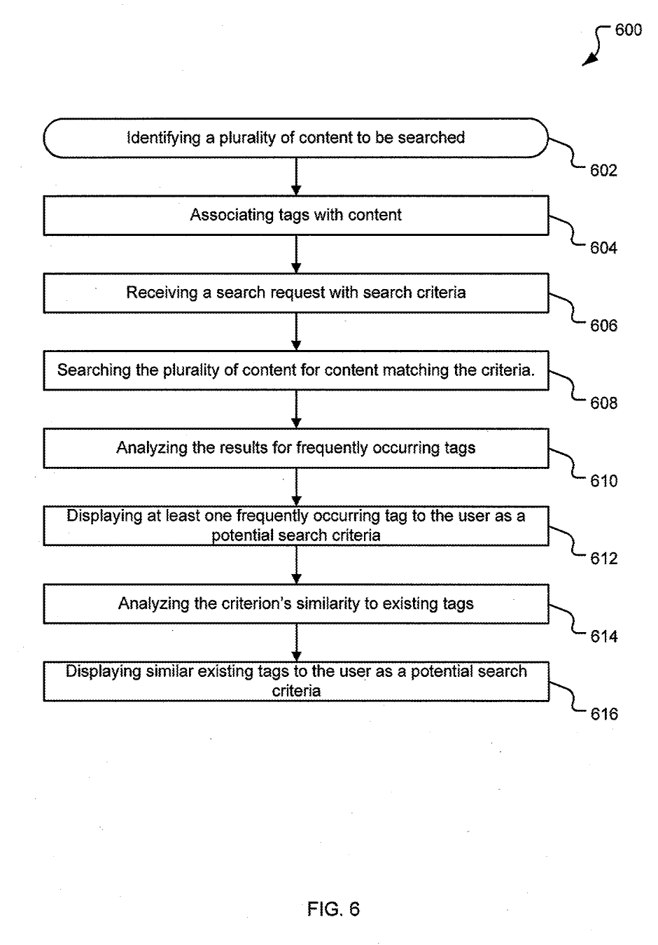

FIG. 6 is an embodiment of a method 600 of using tags for generating an adaptive search utility in accordance with an embodiment of the present invention. The method 600 begins by identifying a plurality of content items to be searched in an identification operation 602. In an embodiment of the present invention, the content items are feeds that can be subscribed to and that the feed search engine will search when requested by the user and information concerning the identified content is stored in a feed database.

An associating operation 604 then associates with each piece of content one or more tags. In one embodiment, the tags are created by users who have reviewed the content and have directed the search engine to associate the content with this tag. In another embodiment, the tags are created by the publisher of the content. In yet another embodiment, the tags are created by the search engine manager. In an embodiment, the tags and associated content information are stored in a feed database for use during future searches.

In an embodiment, the associating operation 604 includes maintaining information regarding how many users have tagged each piece of content with a given tag. This number is then used to weight the tag and help determine its relevance to the content item and/or its descriptiveness of the content.

In a receive search request operation 606, the search engine receives a request from a user to search for content matching some criteria. The criteria may be a keyword or set of keywords. The criteria may also limit the search to specific types of content with the spectrum pieces of content identified in the identification operation 602. The criteria need not be a pre-existing tag and can be any keyword or combination of symbols entered by the user.

A search operation 608 is then performed. The search operation 608 may include performing a new search of content, may include a search a database built when performing the initial identification operation 602 or may include a combination of searches. The search operation 608 may include updating information in the feed database.

The criteria provided by the user are used to identify pieces of content that match the search. The information provided by the content publishers may be searched in addition to any additional descriptive information, such as reviews and tags, subsequently created by third parties and associated with the content in the feed database. The results of the search may include a set of content items that match the criteria.

Next a first analysis operation 610 identifies any frequently occurring tags that are associated with the content in the search results set. Tags that are frequently associated with the same piece of content may be weighted more than tags that are associated only once. For example, a weighted score for each tag associated with the content in the search results set may be generated. The weighted score may be based on the number of pieces of content a tag is associated with compared to the total number of pieces of content and may also be based on the number of times a tag has been associated with each piece of content. The weighted score for each tag may then be compared to a pre-determined threshold normalized to the search results and tags with weighted scores in excess of the threshold are selected. Alternatively, one or more of the tags most frequently associated with the content in the search results may be selected. The first analysis operation 610, one or more tags are selected as related tags to the search result set.

A first display operation 612 then displays the related tags to the user who submitted the search and notifies the user that the related tags may, when used as search criteria, provide better search results than the criteria originally chosen.

A second analysis operation 614 may also be performed. In the second analysis operation the search criteria is compared to existing tags in the feed database. Based on the comparison one or more tags may be selected as “also try” tags that potentially may provide better search results to the user. Again the comparison may be based on the relative number of times the tags have been associated with content in the feed database, both in terms of number of pieces of content each tag has been associated with and overall number of times each tag has been associated with specific pieces of content. The second analysis operation 614 is followed by a second display operation 616 that displays the to the user who submitted the search and notifies the user that the related tags may, when used as search criteria, provide better search results than the criteria originally chosen.

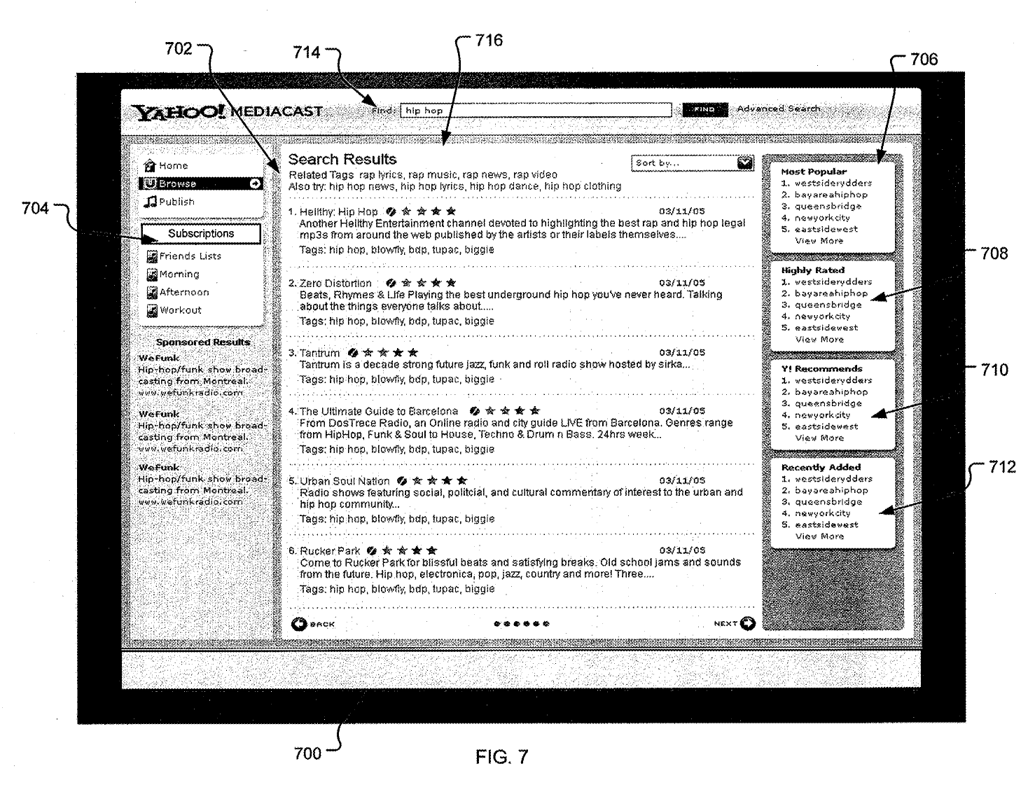

FIG. 7 is an embodiment of a user interface 700 showing the results of a podcast search limited to series according to one embodiment of the present invention. The user interface 700 is a GUI 700 that is divided into several areas including a search area 714 at the top of the GUI 700 and a search results area 716. In addition, the GUI 700 includes a related tags area 702 that shows tags that are similar to the search criteria used to generate the results shown.

In the embodiment shown, for example, a search was done on “hip hop” which may or may not be a pre-existing tag in the feed database 174. The related tags area 702 displays other tags including “rap lyrics,” “rap video,” etc. These related tags are generated by comparing the results associated with the search term “hip hop” and the relative prevalence of other tags associated with those results. Tags other than the search criteria that are associated with a number (e.g., most, every one) of the results may be identified as related tags. In one embodiment, a threshold such as 90% is chosen and if a search returns results in which 90% or more of the identified series and episodes are associated with a pre-existing tag, that tag will be shown as a related tag. Additional tags that do not meet the threshold criteria for a related tag may be displayed in an “also try” group. This group may use a lower threshold or may be based on how well the criteria match to other tags. In the embodiment shown, while “hip hop” is not a tag, several tags include the term hip hop and these tags are returned under the heading “also try.”

The related tags area 702 of the interface 700 is provided to direct users into more frequently used tags. This assists users whose choice of keywords may be eclectic or outside of the mainstream (e.g., the choice of “parody” instead of “humor” or “funny”). Such a related tag identification system is useful when not using pre-defined categories. When pre-defined categories are used, the user has no choice but to either word search the available data provided by the publisher or rely on the categorization system set up by the manager of the search engine. By using tags (possibly in addition to pre-defined categories), more flexible searches, and more specific searches may be provided to a user.

The interface 700 also includes a subscriptions area 704. This area contains a list of all podcasts currently subscribed to by the processor 103 that is in contact with the subscription server 118. The subscriptions may be categorized by the user as shown or simply provided in a list.

The interface 700 also includes a most popular area 706 which may display feeds that currently have the most subscribers. A most highly rated area 708 is provided showing the five most highly rated feeds based on consumer-generated ratings. A recommendations area 710 is provided that makes recommendations to the user based on the users past subscriptions and other information concerning the user containing the user information database. A recently added area 712 is also provided that shows five podcasts that have been recently published. The five recently added may be selected based on their rating, if any, and when they were first published and found by the search engine as well as how they compare to the existing user information.

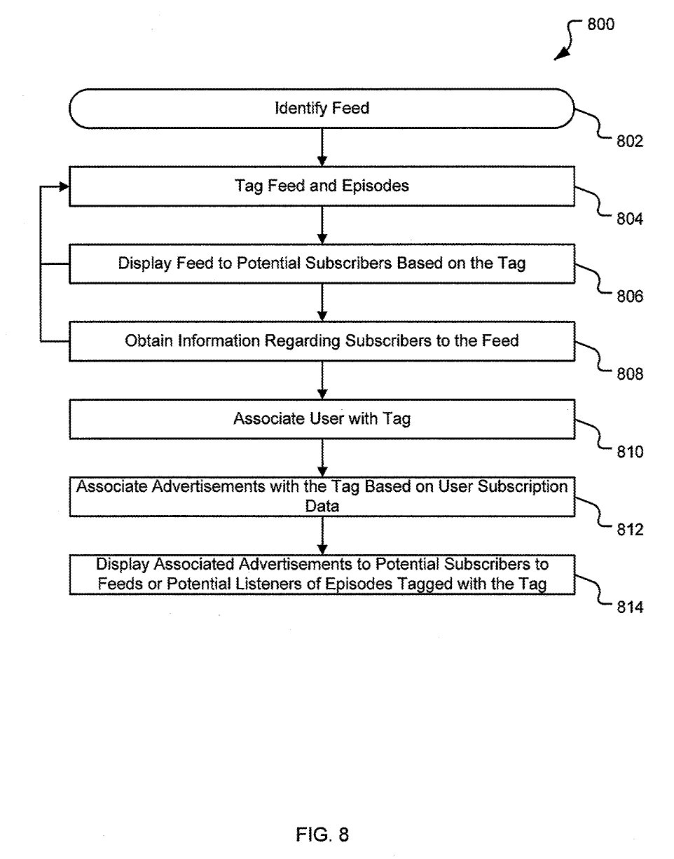

FIG. 8 is a flowchart depicting an embodiment of a method 800 for generating revenue from podcasting in accordance with the present invention. The method 800 starts with the identification of a specific feed in an identification operation 802. This may be the result of a search for feeds previously not known to the searcher. In an embodiment, the feed search engine periodically searches the Internet for previously unavailable feeds. Any new feeds are identified and the pertinent information is obtained from the feed and stored in the feed database.

After the specific feed is identified, one or more tags are created to describe the feed and each episode in the series in a tagging operation 804. In an embodiment, these tags may be initially submitted to the search engine by a publisher. The tags may also be generated by the consumers of the media, i.e., the subscribers to the specific feed and listeners to its episodes.

In an embodiment, tagging operation 804 is an ongoing operation that includes collecting additional tags as they are submitted by consumers over time. In an embodiment, a feed may be tagged with the same tag by multiple users over time. This information may be collected and stored in the feed database and associated with the appropriate series and episodes. A tag that is submitted by different consumers repeatedly for the same feed or episode is given relatively more weight as an accurate description of the contents of the series and episodes as the content is perceived by the user. Similarly, as the user's perception of the content changes, the use of a given tag may change over time.

After the feed has been identified and has been associated with at least one tag, the tag may be used as part of search algorithm to display feeds and episodes of feeds to potential consumers of the feed in a tag-based display operation 806. The tag-based display operation 806 includes using the tags associated with feeds in the feed database to generate search results and to present those results to potential consumers. As the tags associated with the feed evolve over time, the search results for any given search criteria will also change over time. As the specific feed is displayed, new tag information may be submitted, hence the process flow arrow back to the tagging operation 804.

When consumers subscribe to the specific feed or listen to one of its episodes, an obtain information operation 808 is performed. The operation 808 may include requesting additional information from a consumer before executing the subscription or retrieving information already stored about the consumer from a user database. Such user information may include age, location, gender, political, occupational, or other information about the user or the user's device.

The user information is then associated with the tag in a first association operation 810. This operation 810 may include storing user information in a database that is associated with the tag. As the use of the tag evolves, the user information associated with the tag may evolve also and such information may be periodically updated.

A second association operation 812 associates advertisements that target specific consumers with the tags used to identify feeds in the feed database. The association may include comparing the target market of the advertisement with the consumer data associated with the tag. As the tag evolves to be associated with different content and different users, the advertisements identified by the association step will also evolve.

The associated advertisements are then automatically displayed with search results based on the consumer-generated tags associated with the feeds and episodes in the search results in a display advertisement operation 814. Thus, the advertisement is not directly associated with a specific feed or episode. The advertisement may not be directly associated with the search criteria being used to generate the search results. The advertisement is displayed because of the consumer-generated descriptions of the actual feeds or episodes being displayed in response to a search request.

For example, a fanciful tag (e.g., a user-generated tag that describes or is directed to a quality of a content item or to the popularity of a content item, such as “zzzz,” “hot,” “crucial,” or “grassroots media”) may have been created to describe some specific feed. As the feed becomes popular and the fanciful tag is submitted multiple times a distinct consumer demographic may be identified with the tag, even though the tag itself may have little meaning outside of the demographic meaning. An advertisement associated with the fanciful tag, then, may ultimately be displayed with feeds popular with the demographic that uses the tag but that are otherwise unrelated in content to the originally tagged feed and also unrelated to any search criteria that would return the originally tagged feed. However, because of the association of the tag with advertisement, later feeds also associated with the tag may now be displayed with the advertisement.

The method 800 also allows specific episodes within feeds to be automatically associated with different advertisements that would normally be associated with the feed. This is because each episode may be associated with one or more tags that need not be the same as the tags associated with the feed. Thus, when Rush Limbaugh publishes an episode in which he presents his entire discussion in iambic pentameter, the episode may be automatically associated with advertisements associated with humor-based tags, such an association being driven by the consumer-based description of the episode, rather than the publisher's or search engine's description or assignment of keywords to the episode or the feed.

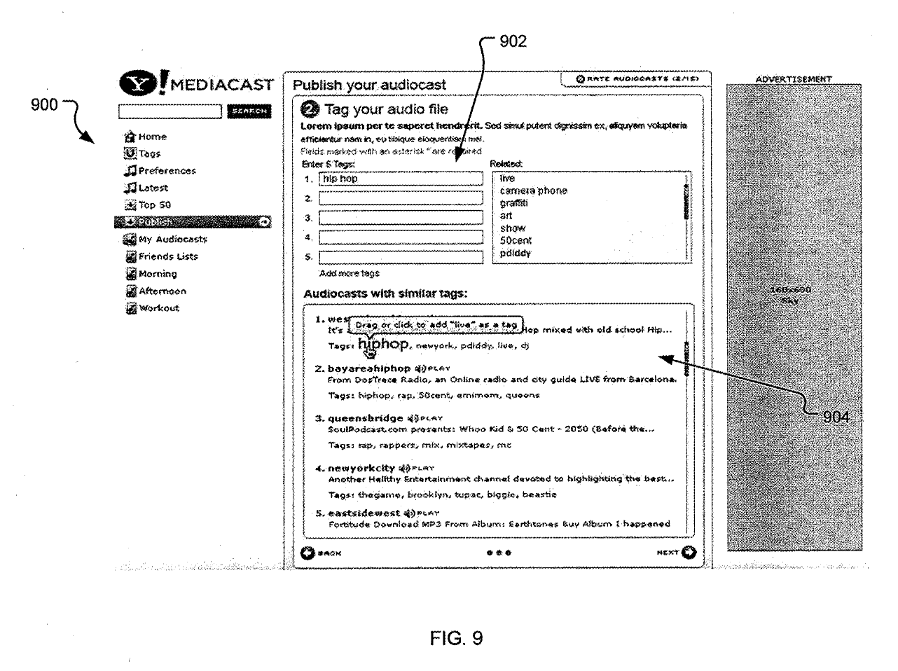

FIG. 9 is another exemplary user interface for publisher submission of a media file to the search engine according to one embodiment of the present invention. The media file submission GUI 900 is provided with a tag selection area 902 and a search results area 904.

The GUI 900 is presented to a user after the submission of media file information to the search engine. The tag selection area 902 displays a list of tags entered by the user in the tag entry text box. The tags submitted by the user are displayed and selectable. Upon selection, a list of related tags (i.e., related to the selected tag) next to the list of submitted tags is shown. This provides the user with additional information for the publisher to consider when selecting tags. Such information is important if the publisher is ultimately limited to submitting a fixed number of tags.

The list of related tags may be generated in any of the manners described herein. By generating a list for a publisher in a similar manner to the way a list will be generated by a user searching for a content item or a tag. In one embodiment, the publisher may see a similar searching presentation in order to strategically pick the tags associated with the publisher's content item. In another embodiment, the publisher may see a different search presentation from the search presentation seen by a user when searching for content items. For example, the publisher may be presented with a representation of tag densities, user information relating to the tag densities (and user-generated tag associations), or other information that may influence the publisher's choice of tags for a content item. In one embodiment, the subscription server 118 may charge a publisher for access to such information.

The GUI 900 is further provided with a search results area 904. The area 904 includes a listing of series that are associated with the currently selected submitted tag in the tag selection area 902. This provides the publisher with additional information to consider when selecting tags for the content item he wishes to publish.

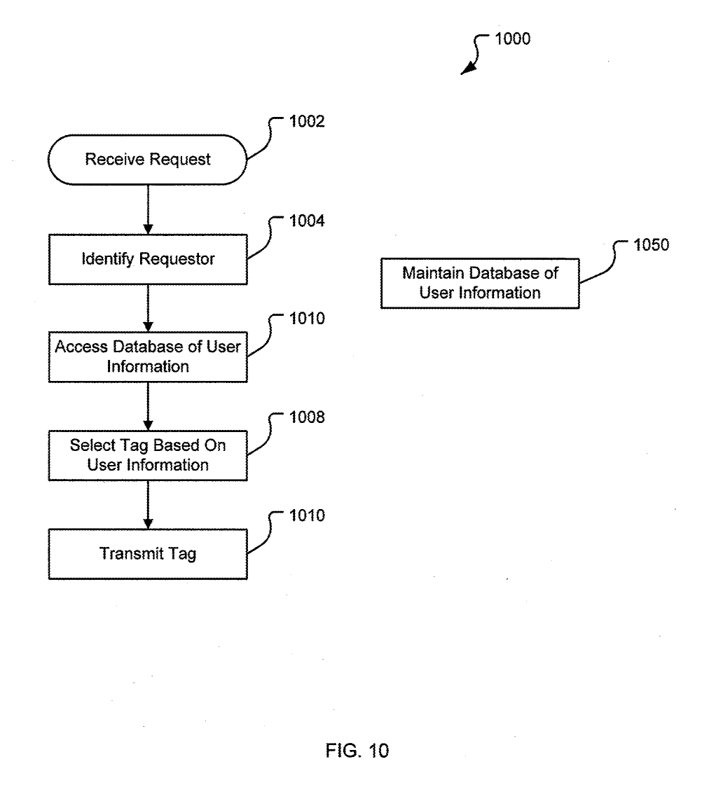

FIG. 10 is a flowchart depicting in greater detail an embodiment of a method for recommending a tag and providing it in response to a request for a content item in accordance with the present invention. In the embodiment 1000, user data from the user database 170 is accessed in order to select a tag based on information associated with a user related to the request.

In the embodiment 1000, a user information datastore is maintained 1050 and accessible to the tag recommendation system. The user information datastore may be a remote database accessible to the tag recommendation system, such as the user information database 170 in FIG. 1, or may be a user database maintained by the tag recommendation system. The user information datastore includes user information associated with each user known to the datastore. As discussed above, user information may include information actively provided by the user, such as demographic information, location, address, and interests, obtained in response to a request for the user to describe himself to the community served by the subscription server 118. The user information may also include a history of the user's transactions and interactions with the subscription server 118. For example, the user information may include a history of all the tags accessed, searched, submitted, or rejected by the user within a certain time period, such as within the last 30 days, which can be referred to as an tag contact history.

In an embodiment, each user known to the user information datastore may be identified by a user identifier and each user identifier is associated with different user information. The user identifier may be a user selected identifier or may be an identifier, not explicitly known to the user, that may be included in a cookie or other data element on the user's computing device from which the user information datastore can identify the user. Thus, in an embodiment, a user may need to log in to the subscription server 118 and thereby allowing the system to explicitly authenticate the user's identity, after which all requests during the session are associated with the user. In an alternative embodiment, authentication is automatic and the user's identity can be determined from inspection of requests from the user.

In the embodiment 1000, a request is received in a receive request operation 1002. Next, the identity of the requestor is identified in an identify requester operation 1004. The identify requester operation 1004 may include inspecting the request to identify a user identifier. Alternatively, other information may be used to identify the requestor, such as a previously provided user identifier associated with the session that the request is part of or associated with a computing device previously used by the user.

The requestor identified may be a user whose rendering device is the ultimate destination to which the tag or search results should be transmitted, which may or may not be may be the same as the source of the request. For example, the request received in receive operation 1002 may be received by the recommendation system from an intermediary, such as the subscription server 118 or some other computing device. The intermediary may be simply forwarding requests received to the tag recommendation system or the intermediary may be generating ad selection requests in response to or in anticipation of user requests. The request received by the recommendation system may include a direction to the recommendation system to transmit the selected tags directly to the source of the initial request, i.e., the user, or may direct the recommendation system to return the tag to the intermediary for subsequent transmittal to the source of the initial request.

After the requestor is identified, the user information datastore is accessed in an access user datastore operation 1006 and information associated with the requester is obtained. The user information is then used to select an tag in a selection ad operation 1008. The information accessed in the access user datastore operation 1006 may be simply inspected or otherwise retrieved from the datastore as necessary depending how the system is implemented.

The select tag operation 1008 selects a tag based on the user information associated with the requestor and ad selection criteria, which may be embodied in a set of ad rules as discussed above. For example, if the requester is associated with user information related to football, the tag selected may be a football-centric version of tag rather than a default tag designed to appeal to all audiences. The selected tag is then transmitted as directed by the request in a transmission operation 1010.

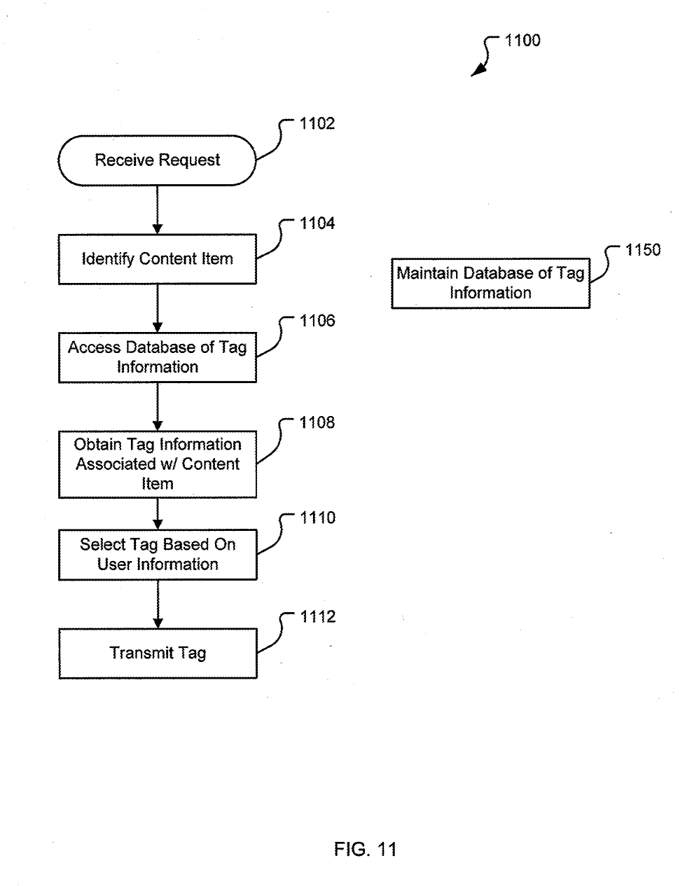

FIG. 11 is a flowchart depicting in greater detail yet another embodiment of a method for selecting a tag in accordance with the present invention. In the embodiment 1100, tag information, such as that in a feed database described above, is accessed in order to select a tag based on information associated with the requested media file.

In the embodiment 1100, a tag information datastore is maintained 1150 and accessible to the advertisement selection system. The tag information datastore may be a remote database accessible to the recommendation system, such as the feed database 174 in FIG. 1, or may be a tag database maintained by the recommendation system. The tag information datastore includes tag information associated with content items, such as a set of one or more tags, identifiers of users that provided the tags, the number of times each tag has been associated with a given media file.

In an embodiment, each content item known to the tag information datastore may be identified by a content item identifier and each content item identifier is associated with different tag information. In an embodiment, the content item identifier is the URL or some other network location identifier for the content item. In an alternative embodiment, the content item may be identified by some other method, such as via metadata within the content item in which case the content item may need to be obtained or inspected before the content item can be identified by the recommendation system.

In the embodiment 1100, a request is received in a receive request operation 1102. The request may be a request for a media file or, alternatively, a request that is somehow associated with a content item such as a request for description information associated with a content item. Next, the identity of the content item is identified in an identify content item operation 1104. The identify content item operation 1104 may include inspecting the request to identify a content item identifier, such as a URL. Alternatively, the content item may need to be retrieved and inspected in order to identify the content item sufficiently for the purposes of the remaining operations.

After the content item is identified, the tag information datastore is accessed in an access tag datastore operation 1106 and information associated with the content item is obtained in an obtain tag information operation 1108. The tag information is then used to select a tag in a tag selection operation 1110. The information obtained in the obtain tag information operation 1108 may be simply inspected or otherwise retrieved from the datastore as necessary depending how the system is implemented.

The select tag operation 1110 selects a tag based on the tag information associated with the media file and a tag selection criterion, which may be embodied in a set of tag rules as discussed above. For example, if the media file is associated with tag information related to football, the tag selected may be a football-centric version of tag rather than a default tag designed to appeal to all audiences. For example, a tag “fantasy” may be targeted at a football-centric user differently than the same tag is targeted at a user whose hobbies contain role playing games. The selected tag is then transmitted as directed by the request in a transmission operation 1112.

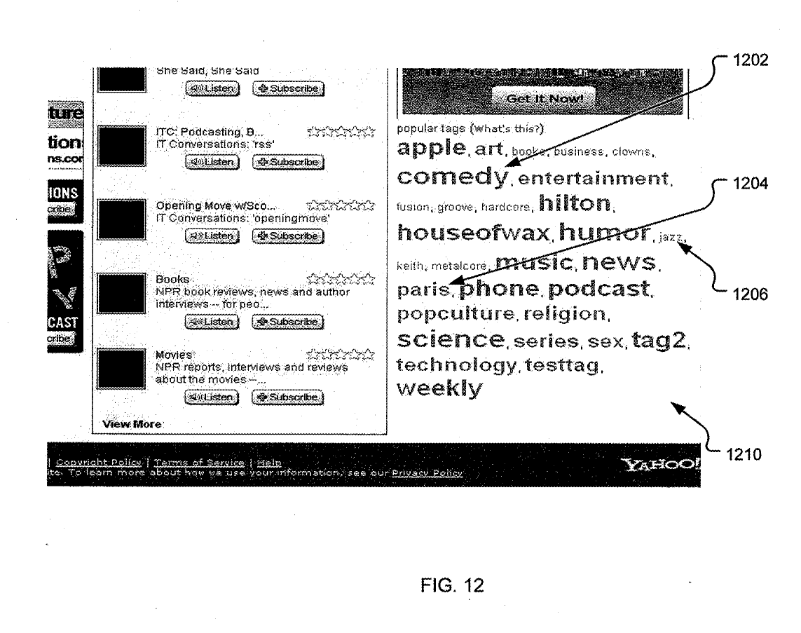

FIG. 12 is an exemplary embodiment of a cloud of tags 1210 presented to signify varying densities. The densities presented by the cloud of tags 1210 may be determined in any of the manners described herein. Therefore, the tag densities may represent a measure of a number of times a user has associated a tag with a particular content item, or any other aggregated data (as described further herein) that may be presented in a cloud-like format. For example, the tag densities presented by the tag cloud 1210 may be aggregated tag densities compiled from a number of highly-rated and popular content items. The presentation may be made via a user interface (as shown), or may be developed to be read by a machine (e.g., for use in selecting content items to include or exclude from a subscription).

In the embodiment shown, the cloud of tags 1210 includes small tags 1206, tags of a medium size 1204 and large tags 1202. The cloud of tags 1210 may be presented in any number of graphical or other manners. For example, in the embodiment shown, tags may be listed alphabetically, but differentiated as to their importance (e.g., densities) using differing font presentations.

The tags in the cloud of tags may each be embodied by links that are selectable by a user. In one embodiment, selection of a tag activates a link and performs a search based on the tag. In another embodiment, the selection of a tag activates a link and creates a presentation (e.g., a view) of the densities of that tag with a group of content items that has already been returned as a group of search results. For example, a user may wish to see which content items, and to what extent the content items, are associated with the tag selected. In yet another embodiment, selection of the tag activates a link that creates a presentation with a different set of content items from the original search (e.g., at least one new content item) and a new group of related tags.

The tag cloud 1210 may include various differentiations between the tags. Various differentiations may be used to facilitate a user in determining which tag to select. For example, size, color, placement, actions (links to tags or content items) may be used to create an intuitive, user-friendly, and/or visually appealing presentation of the cloud of tags 1210. Various other elements may also be added (e.g., a globe, a horizon, a web) that are not specifically tags, but may aid a user in using the tag cloud 1210.

The tag cloud may also adapt, deform, and/or adjust as a user rolls a selection cursor (e.g., a mouse marker) over the tag cloud. In one embodiment, a portion of the cloud 1210 may “expand” underneath a user's cursor, allowing a user to target a desired tag easily from far away. In another embodiment, a portion of the cloud 1210 may display different information or more tags when a user's cursor is over the cloud. For example, the cloud 1210 may display additional tags to the cloud, the additional clouds being related to the tag over which the user's cursor is placed. In yet another embodiment, the entire cloud 1210 may “shrink” or minimize when a user's cursor is not over the cloud.

The cloud 1210 may be machine-readable. The cloud 1210 may assist search engines, web-crawlers, and/or web-archivers in determining relevant content in the same manners described herein for users. In one embodiment, the cloud 1210 is machine-readable in addition to being perceivable by users. In another embodiment, a different cloud is presented that is machine-readable from the cloud intended to be used by human users. For example, a condensed cloud may be used by machines (e.g., without code or instructions for rendering differences) and machines may be able to use more specific data (e.g., exact tag densities, raw data) than a user can. In another embodiment, a version of the raw data or aggregated data stored by the subscription server 118 is made available as a machine-readable tag cloud for machines to determine relevant content items.

In one embodiment, tag densities may be used to automatically include a content item in a subscription. The tag densities so used may be determined in the manners described herein in order to determine whether a content item is appropriate for inclusion into a subscription. In addition, the subscription inclusion decision may be influenced by a user's search history (e.g., the user's tag contact history) and by a user's choice to allow a subscription to be automatically updated, modified or adapted to the user's preferences. Any user information collected by the subscription server 118 may be used for the subscription inclusion decision (e.g., preferences, ratings given to content items, recommendations received). A user may receive added benefit or enjoyment from a subscription that is automatically adapted based on the user's preferences as they change or evolve.

Those skilled in the art will recognize that the methods and systems of the present invention within this specification may be implemented in many manners and as such is not to be limited by the foregoing exemplary embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible. For example, the above discussed methods could be used to provide multiple advertisements with a single media file. The system may be implemented so that each rendering of a media file, even a media file already stored locally on a rendering device, results in the selection and rendering of a new ad for which the publisher is rewarded and the advertiser is billed. As another example, the system could be used to select ads for any situation, such as in response to a request for a web page on a specific subject, or in response to a user's use of a specific software component. Thus, the embodiments of the present invention are not limited to use with media files, but can be used to automatically select ads in response to any digital transaction.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known and features of those variations and modifications through the system component described herein as would be understood by those skilled in the art.

What is claimed is:

1. A content item recommendation system comprising:
a database configured to store an identifier of a first content item, a first tag and information from which a tag density associated with the first tag and with the first content item may be derived, tag density being a measure of times a tag has been associated with a content item by different users of a plurality of users;
a recommendation engine configured to receive search results containing the first tag from a search engine and to correlate the first tag with information stored in the database; and
wherein the recommendation engine is further configured to determine a recommended tag, based on a recommendation threshold and a tag density, the tag density associated with both the recommended tag and the first content item.

2. The system of claim 1, further comprising:
a tag association module configured to accept a user-suggested tag as a descriptor of a content item from a first user of the plurality of users, the tag association module further configured to associate the user-suggested tag with the content item.

3. The system of claim 1, wherein the tag association module is further configured to access the database to associate the user-suggested tag with user information stored in the database.

4. The system of claim 1, wherein the recommendation engine is further configured to determine a recommended content item, based on the recommendation threshold and a tag density associated with both the recommended tag and the recommended content item.

5. A method of providing recommendations with results of a first search, comprising:
retrieving a first tag from a set of results of a first search for content items;
performing a second search based on the first tag, includes identifying a first content item that has been associated with the first tag;
wherein the identifying a first content item includes,
determining a first tag density, wherein the first tag density is a measure of the number of times the first tag has been associated with the first content item;
making a determination based on the first tag density and a first threshold;
wherein the performing the second search includes identifying a recommended tag associated with the first content item; and
wherein the identifying a recommended tag includes,
determining a recommended tag density, wherein the recommended tag density is a measure of the number of times the recommended tag has been associated with the first content item;
making a determination based on the recommended tag density and a recommendation threshold.

6. The method of claim 5, including:
presenting the recommended tag with the set of results from the first search.

7. The method of claim 6, wherein presenting the recommended tag further comprises:
providing a user-selectable link wherein selection of the link by a user initiates a search of content items associated with the recommended tag.

8. The method of claim 5, wherein the recommended tag is not contained in the set of results from the first search.

9. The method of claim 5, wherein the first content item is not contained in the set of results from the first search.

10. The method of claim 5, wherein performing further comprises:
identifying a recommended content item;
wherein identifying a recommended content item includes,
determining a second tag density, wherein the second tag density is a measure of the number of times the recommended tag has been associated with the recommended content item;
making a determination based on the second tag density and a second threshold.

11. The method of claim 10, further comprising:
presenting the recommended content item with the set of results from the first search.

12. A method comprising:
receiving a search request for content items associated with a first tag;
generating a set of related tags based on the first tag;
correlating the first tag and a candidate tag contained in the set of related tags to determine a recommended tag; and
returning the recommended tag.

13. The method of claim 12, wherein correlating further comprises:
ascertaining a first tag density, the first tag density being a measure of the number of times the first tag has been associated with a first content item;
ascertaining a candidate tag density, the candidate tag density being a measure of the number of times the candidate tag has been associated with a first content item;
making a determination based on the first tag density and the candidate tag density.

14. The method of claim 13, wherein making a determination comprises:
comparing the first tag density and a first threshold;
comparing the candidate tag density and a second threshold.

15. The method of claim 13, wherein making a determination comprises:
comparing the first tag density and the candidate tag density.

16. The method of claim 12, wherein generating further comprises:
identifying a plurality of content items, wherein each of the plurality of content items is associated with the first tag.

17. The method of claim 16, wherein each of the plurality of content items is associated with the first tag, and has a tag density associated with the first tag greater than a first threshold.

18. The method of claim 12, wherein the first tag is not contained in the search request.

19. The method of claim 12, wherein the search request includes a link to a content item.

20. The method of claim 19, wherein the content item not associated with the first tag.

21. The method of claim 12, wherein the first tag is contained in a set of search results generated in response to the search request for content items.

22. The method of claims 21, wherein the recommended tag is not contained in the set of search results.
